(19) United States
(12) Patent Application Publication
(10) Pub. No.: US 2012/0253855 A1
(43) Pub. Date: Oct. 4, 2012

(54) CAPTURING A FUTURE LOCATION OF AN ONLINE USER

(76) Inventors: Ashootosh Chand, Bangalore (IN); Suresh Kumar, Bangalore (IN)

(21) Appl. No.: 13/079,738

(22) Filed: Apr. 4, 2011

(51) Int. Cl. G06Q 10/00; G06N 5/02

(52) U.S. Cl. 705/5; 706/46

(57) ABSTRACT

A method and a system are provided for capturing a future location of a user. In one example, the system receives user data including plans for one or more future locations of one or more users. The system identifies a particular user who is associated with one or more users who plan to go to a particular future location. The system then provides to a particular user device a suggestion for the particular user to be at the particular future location. The particular user device is presumably operated by the particular user.

### FIELD OF THE INVENTION

The invention relates to online advertising. More particularly, the invention relates to monetizing future locations of online users.

### BACKGROUND

An advertiser, such as Ford™ or McDonald's™, generally contracts a creative agency for ads to be placed in various media for the advertiser's products. Such media may include TV, radio, Internet ads (e.g., sponsored search ads, banner display ads, textual ads, streaming ads, mobile phone ads, etc.) or print medium ads (e.g., ads in newspapers, magazines, posters, etc.). It is quite possible that the advertiser may engage one or more creative agencies that specialize in generating ads for one or more of the above media. A company wants to show the most relevant ads to end users to obtain the most value from their ad campaign.

A useful consideration in targeting users is the future location of the users. For example, if an online user is going rock climbing in Yosemite, or if an online user is going to the Great Mall in San Jose, then it would be advantageous for an advertiser to know such information. With future location information, the advertiser can aim ads more accurately to particular users who may be interested in products and/or services that are related to the future location. Unfortunately, there has been no reliable way to determine future locations of users.

### SUMMARY

What is needed is an improved method having features for addressing the problems mentioned above and new features not yet discussed. Broadly speaking, the invention fills these needs by providing a method and a system for capturing a future location of an online user.

In a first embodiment, a computer-implemented method is provided for capturing a future location of a user. The method comprises the following: receiving, at a computer, user data including plans for one or more future locations of one or more users; identifying, at a computer, a particular user who is associated with one or more users who plan to go to a particular future location; and providing to a particular user device a suggestion for the particular user to be at the particular future location, wherein the particular user device is presumably operated by the particular user.

In a second embodiment, a system is provided for capturing a future location of a user. The system comprises a computer system configured for the following: receiving, at a computer, user data including plans for one or more future locations of one or more users; identifying, at a computer, a particular user who is associated with one or more users who plan to go to a particular future location; and providing to a particular user device a suggestion for the particular user to be at the particular future location, wherein the particular user device is presumably operated by the particular user.

In a third embodiment, a computer readable medium is provided comprising one or more instructions for capturing a future location of a user. The one or more instructions are configured for causing one or more processors to perform at least the following steps: receiving, at a computer, user data including plans for one or more future locations of one or more users; identifying, at a computer, a particular user who is associated with one or more users who plan to go to a particular future location; and providing to a particular user device a suggestion for the particular user to be at the particular future location, wherein the particular user device is presumably operated by the particular user.

The invention encompasses other embodiments configured as set forth above and with other features and alternatives. It should be appreciated that the invention may be implemented in numerous ways, including as a method, a process, an apparatus, a system or a device.

### BRIEF DESCRIPTION OF THE DRAWINGS

The invention will be readily understood by the following detailed description in conjunction with the accompanying drawings. To facilitate this description, like reference numerals designate like structural elements.

FIG. 1 is a high-level block diagram of a system for capturing a future location of a user, in accordance with some embodiments;

FIG. 2 is a schematic diagram of a system for capturing a future location of an online user, in accordance with some embodiments;

FIG. 3 is a flowchart of a method for capturing a future location of an online user, in accordance with some embodiments; and

FIG. 4 is a diagrammatic representation of a network, including nodes that may comprise a machine within which a set of instructions may be executed, in accordance with some embodiments.

### DETAILED DESCRIPTION

An invention is disclosed for a method and a system for capturing a future location of an online user. Numerous specific details are set forth in order to provide a thorough understanding of the invention. It will be understood, however, to one skilled in the art, that the invention may be practiced with other specific details.

### DEFINITIONS

Some terms are defined below in alphabetical order for easy reference. These terms are not rigidly restricted to these definitions. A term may be further defined by the term's use in other sections of this description.

“Ad” (e.g., ad, item and/or message) means a paid announcement, as of goods or services for sale, preferably on a network, such as the Internet. An ad may also be referred to as an ad, creative, an item and/or a message.

“Ad server” means a server that is configured for serving one or more ads to user devices. An ad server is preferably controlled by a publisher of a Web site and/or an advertiser of online ads. A server is defined below.

“Advertiser” (e.g., messenger and/or messaging customer, etc.) means an entity that is in the business of marketing a product and/or a service to users that desires to send a message about the product and/or service. An advertiser may include, without limitation, a seller and/or a third-party agent for the seller. An advertiser also includes agents that represent advertisers for purposes of delivering online ads (See below). An advertiser may also be referred to as a messenger and/or a messaging customer. Advertising may also be referred to as messaging.

“Advertising network” or “ad network” means an entity that integrates other entities, such as advertisers and publishers, to deliver ads online. An advertising network typically operates in conjunction with advertisers and publishers in order to deliver ads, from one or more advertisers, to Web pages of one or more publishers. For example, Yahoo!™ Inc. may operate such an advertising network.

“Advertising” means marketing a product and/or service to one or more potential consumers by using an ad. One example of advertising is publishing a sponsored search ad on a Web site.

“Agent” or “integrator network” means an entity of an online advertising system that represents or integrates one or more entities on the advertising system (e.g., advertisers, publishers, advertising networks, etc.). For example, an integrator network may represent advertisers on the advertising system in order to deliver advertisements to publishers, advertising networks and other integrator networks.

“Application server” means a server that is configured for running one or more devices (e.g., software and/or hardware) loaded on the application server.

“Click” (e.g., ad click) means a selection of an ad impression by using a selection device, for example, a computer mouse or a touch-sensitive display.

“Click-through rate” (CTR) means a measurement of how many times users click on an ad per unit view. CTR preferably equals ad clicks per ad views.

“Client” means the client part of a client-server architecture. A client is typically a user device and/or an application that runs on a user device. A client typically relies on a server to perform some operations. For example, an email client is an application that enables a user to send and receive e-mail via an email server. The computer running such an email client may also be referred to as a client.

“Database” (e.g., database system, etc.) means a collection of data organized in such a way that a computer program may quickly select desired pieces of the data. A database is an electronic filing system. In some instances, the term “database” is used as shorthand for “database management system”. A database may be implemented as any type of data storage structure capable of providing for the retrieval and storage of a variety of data types. For instance, a database may comprise one or more accessible memory structures such as a CD-ROM, tape, digital storage library, flash drive, floppy disk, optical disk, magnetic-optical disk, erasable programmable read-only memory (EPROM), random access memory (RAM), magnetic or optical cards, etc.

“Device” means hardware, software or a combination thereof. A device may sometimes be referred to as an apparatus. Examples of a device include without limitation a software application such as Microsoft Word™, a laptop computer, a database, a server, a display, a computer mouse and/or a hard disk.

“Item” means an ad, which is defined above.

“Marketplace” means a world of commercial activity where products and/or services are browsed, bought and/or sold, etc. A marketplace may be located over a network, such as the Internet. A marketplace may also be located in a physical environment, such as a shopping mall.

“Message” means an ad, which is defined above.

“Messaging” means advertising, which is defined above.

“Messenger” means an advertiser, which is defined above.

“Network” means a connection, between any two or more computers, that permits the transmission of data. A network may be any combination of networks, including without limitation the Internet, a local area network, a wide area network, a wireless network and a cellular network.

“Publisher” means an entity that publishes, on a network, a Web page having content and/or ads, etc.

“Server” means a software application that provides services to other computer programs (and their users), in the same computer or another computer. A server may also refer to the physical computer that has been set aside to run a specific server application. For example, when the software Apache HTTP Server is used as the Web server for a company's Web site, the computer running Apache may also be called the Web server. Server applications may be divided among server computers over an extreme range, depending upon the workload.

“Social graph” means a collection of information pertaining to social interactions and/or social associations between users. A social graph may include identifications of users, identifications of friends of users, identifications of contacts of users, past locations of users, past locations of friends of users, past locations of contacts of users, present locations of one or more users, present locations of friends of users, present locations of contacts of users, declared future locations of users, declared future locations of friends of users, and declared future locations of contacts of users.

“Software” means a computer program that is written in a programming language that may be used by one of ordinary skill in the art. The programming language chosen should be compatible with the computer by which the software application is to be executed and, in particular, with the operating system of that computer. Examples of suitable programming languages include without limitation Object Pascal, C, C++ and Java. Further, the functions of some embodiments, when described as a series of steps for a method, could be implemented as a series of software instructions for being operated by a processor, such that the embodiments could be implemented as software, hardware, or a combination thereof. Computer readable media are discussed in more detail in a separate section below.

“System” means a device or multiple coupled devices. A device is defined above.

“User” (e.g., consumer, etc.) means an operator of a user device. A user is typically a person who seeks to acquire a product and/or service. For example, a user may be a woman who is browsing Yahoo!™ Shopping for a new cell phone to replace her current cell phone. The term “user” may refer to a user device, depending on the context.

“User device” (e.g., computer, user computer, client and/or server, etc.) means a single computer or to a network of interacting computers. A user device is a computer that a user may use to communicate with other devices over a network, such as the Internet. A user device is a combination of a hardware system, a software operating system and perhaps one or more software application programs. Examples of a user device include without limitation a laptop computer, a palmtop computer, a smart phone, a cell phone, a mobile phone, an IBM-type personal computer (PC) having an operating system such as Microsoft Windows™, an Apple™ computer having an operating system such as MAC-OS, hardware having a JAVA-OS operating system, and a Sun Microsystems Workstation having a UNIX operating system.

“Web browser” (e.g., browser) means a software program that may display text, graphics, or both, from Web pages on Web sites. Examples of a Web browser include without limitation Mozilla Firefox™ and Microsoft Internet Explorer™.

“Web page” means documents written in a mark-up language including without limitation HTML (hypertext mark-up language), VRML (virtual reality modeling language), dynamic HTML, XML (extended mark-up language) and/or other related computer languages. A Web page may also refer to a collection of such documents reachable through one specific Internet address and/or through one specific Web site. A Web page may also refer to any document obtainable through a particular URL (Uniform Resource Locator).

“Web portal” (e.g., public portal) means a Web site or service that offers a broad array of resources and services, for example, e-mail, forums, search engines, and online shopping malls. Early Web portals included online services, such as AOL, that provided access to the Web. However, now, most of the traditional search engines (e.g., Yahoo!™) have transformed themselves into Web portals to attract and keep a larger audience.

“Web server” is a server configured for serving at least one Web page to a Web browser. An example of a Web server is a Yahoo!™ Web server. A server is defined above.

“Web site” means one or more Web pages. A Web site preferably includes a plurality of Web pages, virtually connected to form a coherent group.

### General Overview

A user's future location is important for offering a next generation of location aware ads, services, applications and/or monetization. Many users may not explicitly declare their future location. The present system is configured for inferring a future location based on the future locations of friends with whom the user spends time. The system may then use this inference to prompt the user to confirm, or not to confirm, the user's future location. This process is a virtuous cycle that will lead to other users sharing their future location.

A number of visitors to websites do not specify sufficient information about their profile, such as their gender, age, etc. Advertisers, on the other hand, would like to direct their ads as accurately as possible to a target user segment. Any ad servicing entity, such as an ad network, stands to gain a lot if the company can determine future locations of users. An ad servicing entity will then have a larger user base available for fine-grained targeting.

The ad servicing entity may then share future locations with advertisers to use in aimed ad campaigns. Depending on the user's future location, as determined by the ad servicing entity and communicated to the advertisers, the ad servicing entity may charge a suitable premium for targeting end users. The premium may be proportional to the accuracy and confidence level of the future locations. Future locations will increase the target user segment base and lead to increased advertising revenue. The advertisers stand to benefit with increased return on investment because they may now reach their goals while limiting the ads to specific target segments.

The net effect of happy advertisers is more revenue for the ad servicing entity. Overall, the system provides a win-win for both the ad servicing entity and the advertisers.

### Architecture Overview

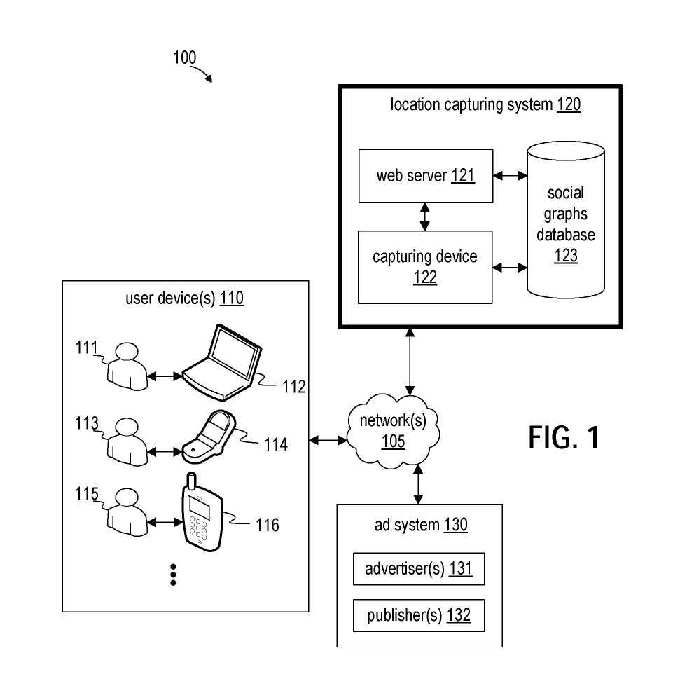

FIG. 1 is a high-level block diagram of a system 100 for capturing a future location of a user, in accordance with some embodiments. The one or more networks 105 couple together one or more user devices 110, an ad system 130, and a location capturing system 120. The network 105 may be any combination of networks, including without limitation the Internet, a local area network, a wide area network, a wireless network and/or a cellular network.

Each user device 110 includes without limitation a single computer or a network of interacting computers. Examples of a user device include without limitation a laptop computer 112, a cell phone 114 and a smart phone 116. A user may communicate with other devices over the network 105 by using a user device 110. For example, a user 111, a user 113, and a user 115 may operate the user device 112, the user device 114, and the user device 116, respectively. A user may be, for example, a person browsing or shopping in a marketplace on the Internet.

The location capturing system 120 performs more important operations of the system 100 and is described further below in other sections. The location capturing system 120 may include without limitation application servers, search engines, Web servers, and/or databases. In particular, the location capturing system 120 includes without limitation the following coupled devices: a web server 121, a capturing device 122, and a social graphs database 123. The location capturing system 120 is configured for communicating with the ad system 130, which includes one or more advertisers 131 and one or more publishers 132. The location capturing system 120 is further configured for communicating with the one or more user devices 110 and serving at least one Web page to a Web browser on a user device 110.

The location capturing system 120 is configured with programs, algorithms, applications, software, graphical user interfaces, models, other tools and/or other procedures necessary to implement and/or facilitate methods and systems according to embodiments of the invention, or computerized aspects thereof, whether on one computer or distributed among multiple computers or devices. These include local and global adjustment, decision making, or optimizations, weighting, pricing, allocation, scheduling, serving, and/or other techniques. In various embodiments, the elements of the location capturing system 120 may exist on one computer, or may exist on multiple computers, devices and/or locations.

The ad system 130 may also include without limitation ad servers, application servers and/or databases. The ad system 130 is configured for serving one or more ads to the user devices 110. An ad system 130 is preferably controlled by an advertiser 131 of online ads and/or a publisher 132 of a Web site. An advertiser 131 is an entity that is seeking to market a product and/or a service to users at the user devices 110. Examples of a publisher/advertiser include without limitation Amazon.com™, Nike™ and Yahoo!™. A publisher 132 is an entity that publishes, over the network 105, a Web page having content and/or ads.

The configuration of the system 100 in FIG. 1 is for explanatory purposes. For example, in some embodiments, the advertiser system 130 may be part of an ad exchange. For example, some Web portals operate, utilize, or facilitate advertising exchanges. Such exchanges may virtually connect parties including advertisers, publishers, networks of advertisers, networks of publishers, and other entities. The exchange may facilitate arrangements, bidding, auctioning in connection with ads and ad campaigns, and may also facilitate planning and serving of ads. Ads that may be included within the exchange may include display or graphical ads that are not served in connection with user searches including keyword-based searches. The exchange may also include sponsored search ads, including ads served in association with user searches, such as keyword searches. Any type of simple or sophisticated ads may be included, such as text, graphic, picture, video and audio ads, streaming ads, interactive ads, rich median ads, etc.

In some embodiments, active ads are ads that are available for serving on or in connection with the exchange, whereas non-active ads are not so available. For example, non-active ads may include ads that are in review prior to be available for serving. This may include review as part of an editorial process to try to ensure or reduce the chance that inappropriate or dangerous ads are not allowed to be active. There are numerous other configurations in other embodiments that are possible.

### Capturing a Future Location of a User

Location in the Internet space is about connecting people, places and things. In today's world, future locations have not been used effectively. The usage and monetization of future locations is largely unexplored because the user's future location has typically been unknown.

Most of the existing products are/or services are focused around capturing future location based on users declared intent or inferred from user's action and current location. In most cases, a user does not declare the user's future location because the user does not see a benefit in sharing the user's location and it is difficult to infer future location of value from the user's current location.

Past and present location may be determined in a number of different ways. For example, a web portal, such as Yahoo!™, may have default locations of users by using user profiles that the users may set up. A user may change their user profile at any time. In another example, users may have saved locations that in associated labels, such as “home”, “work” and “school”. In another example, a user may have a queried locations that is entered by users that may be either logged in or logged out on a web portal, such as Yahoo!™. The web portal typically stores a queried location for a time period (e.g., ninety) and then deletes the queried location. In yet another example, the physical current location of a user may be detected by using tracking utilities, such as an Internet protocol (IP) address, a global positioning system (GPS), beacon triangulation, etc.

There are drawbacks to inferring a user's future location based on known past or present locations. The main drawback is that past and present locations of a user are poor predictors of futures locations.

The present system addresses the drawbacks of inferring future locations by blatantly prompting the user to declare the user's future location. Such prompting preferably occurs in scenarios where the user has not declared locations or where the future location cannot be inferred accurately. The present system enables the user to declare the user's future locations easily.

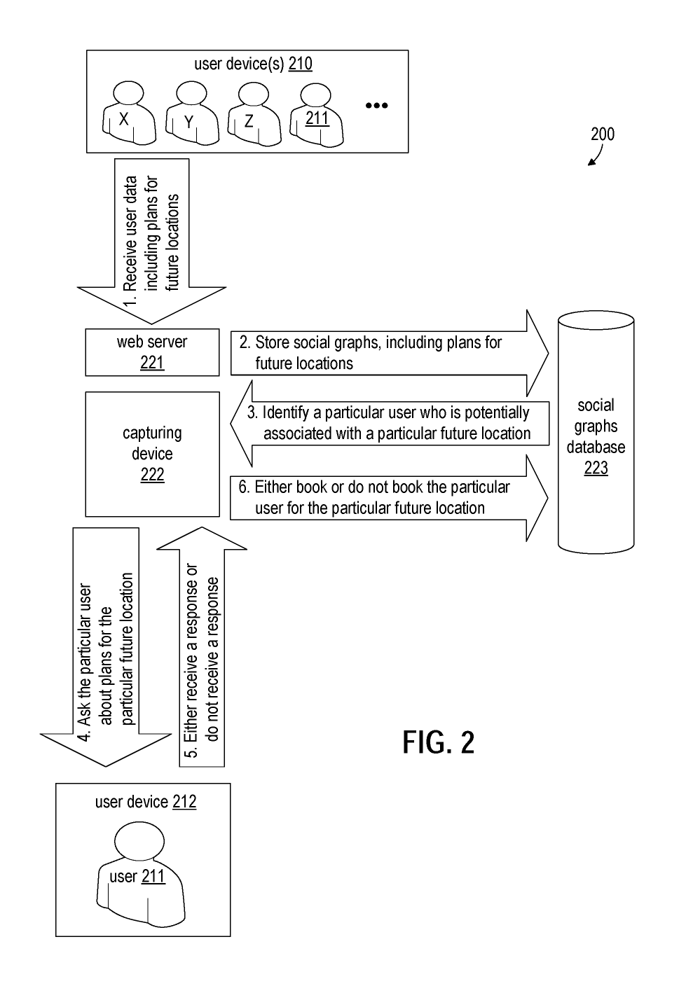

FIG. 2 is a schematic diagram of a system 200 for capturing a future location of an online user, in accordance with some embodiments. The system 200 leverages social graphs to help determine future locations. A social graph is a collection of information pertaining to social interactions between users. A social graph may include identifications of users, identifications of friends of users, identifications of contacts of users, past locations of users, present locations of users, declared future locations of users, and/or other information. The system generates social graphs, matches the social graphs to a particular user's preferences, and attempts to confirm a particular future location for the particular user 211. The system 200 is further described below.

A network application, such as a web server 221, receives a multitude of user data from user devices 210 operated by users. The user data may include, among other things, declared future locations of the one or more users operating the one or more user devices 210. For example, the web server 221 may receive declared future locations from user devices 210 when users declare a future location via a networking application, such as instant messaging (IM) or another social networking application to which the web server 221 has access. Based on the user data received from the user devices 210, the web server 221 may facilitate generation of one or more social graphs for the one or more users. The web server 221 may then facilitate storage of the social graphs in a social graphs database 223.

Using the social graphs in the social graphs database, the capturing device 222 may identify a particular user 211 who is potentially associated with a particular future location. The capturing device 222 identifies a particular user 211 by identifying users who are associated with the particular user 211 and who have declared plans for going to a future location. For example, the capturing device 222 may determine that a particular user 211 typically fraternizes with a specific group of people (e.g., other users). For instance, the capturing device 222 may determine, via the social graphs, the particular user 211 has enjoyed going rock climbing with friends X, Y, and Z.

To identify a particular future location that is to be analyzed, the capturing device 222 may receive, via the social graphs, plans of the friends of the particular user 211 to go to the future location. For example, the particular user's friends X and Y may declare, via instant messaging, plans for going rock climbing next Sunday. The social graphs in the social graphs database 223 may also show, for example, that friend Z is near the location where X and Y are going rock climbing. Based on the historical locations of friend Z who goes rock climbing when close to an appropriate location, the capturing device 222 can infer that friend Z will also join the rock climbing expedition. Further, the capturing device 222 may determine, via the social graphs, that the particular user 211 is a rock climbing enthusiast and that the particular user 211 does not have any specific activity planned for next Sunday.

The capturing device 222 may ask the particular user 211 about plans for the particular future location. For example, a Yahoo!™ Application may send to the user device 212 a suggestion for the particular user 211 to be at the particular future location where the user's friends are planning to go rock climbing. The suggestion may be delivered by using any suitable application that may include, for example, an email, an instant message, a pop-up menu, and/or radio buttons, etc.

The capturing device 222 may either receive a response or not receive a response from the user device 212, which is presumably operated by the particular user 211. The particular user 211 has at least the following three options:

TABLE 1
Options for a User Who Receives a Suggestion
to be at a Future Location

| | |
|---|---|
| Option 1 | Accept the suggestion to be at the particular future |
| | location. For example, answer “Yes”. |
| Option 2 | Deny the suggestion to be at the particular future |
| | location. For example, answer “No”. |
| Option 3 | Do not respond. |

For example, for the first option, the capturing device 222 may receive a response from the user device 212 that the particular user 211 plans to be at the rock climbing destination where the user's friends are planning to visit on Sunday. For the second option, the capturing device 222 may receive a response from the user device 212 that the particular user 211 does not plan to be at the rock climbing destination where the user's friends are planning to visit on Sunday. For the third option, the capturing device 222 receives no response from the user device 212.

In another embodiment, the capturing device 222 may provide at least one other option (not shown in Table 1). The capturing device 222 may provide a way for the particular user 211 to enter a future location without restriction to the suggestion from the capturing device 222. For example, the capturing device 222 may provide a data entry device for the particular user 211 to type in manually, or to select on a geographical map, any future location that the user decides.

If the particular user 211 accepts the suggestion (Option 1 in Table 1) or if the user manually enters another future location, then the capturing device 222 books the selected future location as the user's declared future location. Based on the declaration of the particular user 211, the capturing device 222 may, for example, send suggestions for future locations to other friends who also are rock climbing enthusiasts. As noted above, the capturing device 222 may know the friend connections via the social graphs stored in the social graphs database 223.

Based on the social graphs in the social graphs database 223, the capturing device 222 may recognize that the user is faced with a conflict. For example, the particular user 211 may have already declared to be at another location besides rock climbing on Sunday. In such a case, the capturing device 222 may prompt the particular user 211 to choose the more preferred location between, for example, rock climbing and another future location.

If the particular user 211 denies the suggestion (Option 2 in Table 1), the capturing device 222 records a note in a social graph that indicates the particular user 211 does not plan to go to the particular future location. If the particular user 211 does not respond (Option 3 in Table 1), the capturing device 222 does not book the particular user 211 for the particular future location. After receiving either a response or no response, the capturing device 222 may move on and continue with other processes for capturing future locations for the particular user 211 or for other users.

This system helps in capturing the future locations of where users are more likely to be on a declared date and time. Advantageously, the system 200 utilizes the viral distributions of social connections to induce users to declare future locations. The system 200 can increase the number of users who declare their future locations based on social proximity to be at a certain place at a future date and time. The system 200 can increase the number of captured future locations per user. The system 200 can increase the chances of a user to be at a declared future location because the user's social graph informs the system 200 the user may have a special interest in a particular future location.

### Overview of Method for Capturing a Future Location of a User

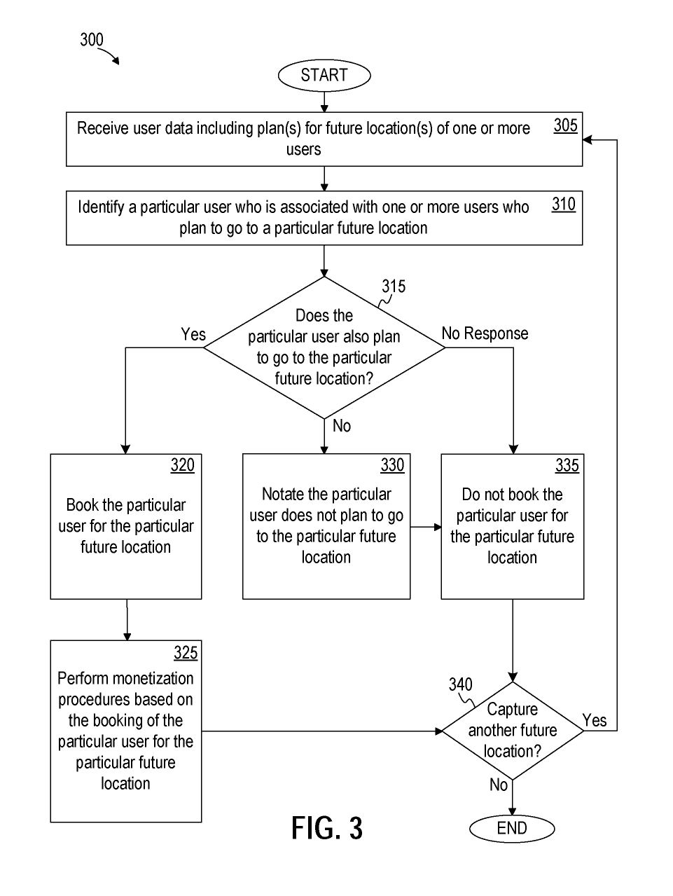

FIG. 3 is a flowchart of a method 300 for capturing a future location of an online user, in accordance with some embodiments. The steps of the method 300 may be carried out by one or more devices of the system 100 of FIG. 100 and/or the system 200 of FIG. 2.

The method 300 starts in a step 305 where the system receives user data including plans for future locations of one or more users. For example, the system may receive, from one or more user devices, user data including declared future locations of the one or more users operating the one or more user devices.

The method 300 moves to a step 310 where the system identifies a particular user who is associated with one or more users who plan to go to a particular future location. For example, the system may use social graphs to identify a particular user who is potentially associated with a particular future location.

The method 300 proceeds to a decision operation 315 where the system determines if the particular user also plans to go to the particular future location. For example, the system may send, to the user device operated by the particular user, a suggestion to be at the particular future location at which the user's friends are planning to be.

In the decision operation 315, if the system receives an acceptance (e.g., a “Yes” response) from the user device, then the method 300 moves to a step 320 where the system books the user for the particular future location. Booking the user means the system receives the confirmation of the future location from the associated user device and records the future location for the user. For example, the system 200 of FIG. 2 may store in the social graphs database 223 the future location for the user. Accordingly, the declared future location is data that further informs at least one social graph associated with the user. A social graph is a collection of information pertaining to social interactions and/or social associations between users. A social graph may include names of users, names of friends of users, past locations of users, present locations of users, future locations of users, and/or other information. As discussed above with reference to FIG. 2, the system uses social graphs to identify a particular user who is potentially associated with a particular future location.

The system may use a declared future location in a social graph to continue the cycle of identifying other friends who may be associated with a particular future location. Such a cycle preferably continues such that the system obtains as many declared future locations as possible. As the number of declared future locations increases, the number of friends who may receive confirmation requests from the system tends to increase as well. As that cycle continues, the cycle naturally builds upon itself.

In FIG. 3, after performing the step 320, the method 300 then proceeds to a step 325 where the system performs monetization procedures based on the booking of the user for the particular future location. For example, an ad servicing entity may share the particular future location with one or more advertisers for use in aimed ad campaigns. For instance, the system 200 of FIG. 2 may allow an advertiser to use at least some of the data in the social graphs database 223, which includes one or more future locations for one or more users. Given a declared future location of a user, an advertiser may send one or more ads that are more precisely targeted toward a particular user who is associated with the declared future location. As one example of such ad targeting, if REI™ knows that a particular user is going snowboarding in Tahoe next week based on the user's declared future location in a social graph, then REI™ may target that user by sending an ad for discounted snowboards that REI™ is selling. Such use of a declared future location adds a level of precision that is not available in other ad targeting schemes.

Alternatively, in the decision operation 315 of FIG. 3, if the system receives a denial (e.g., a “No” response) from the user device, then the method 300 moves to a step 330 where the system notates in a social graph that the user does not plan to go to the particular future location. In another alternative, if the system receives no response from the user device, then the method 300 moves to a step 335 where the system does not book the particular user for the particular future location. Note that if the system performs the step 330, then the method 300 moves on to the step 335 and continues from there.

After the system performs the step 325 or the step 335, the method 300 proceeds to a decision operation 340 where the system determines if another future location is to be captured. If the system determines that another future location is to be captured, then the method 300 returns to the step 305 and continues from there. However, in the decision operation 340, if the system determines that another future location is not to be captured, then the method 300 concludes.

Note that the method 300 may include other details and steps that are not discussed in this method overview. Other details and steps are discussed with reference to the appropriate figures and may be a part of the method 300, depending on the embodiment.

### Exemplary Network, Client, Server and Computer Environments

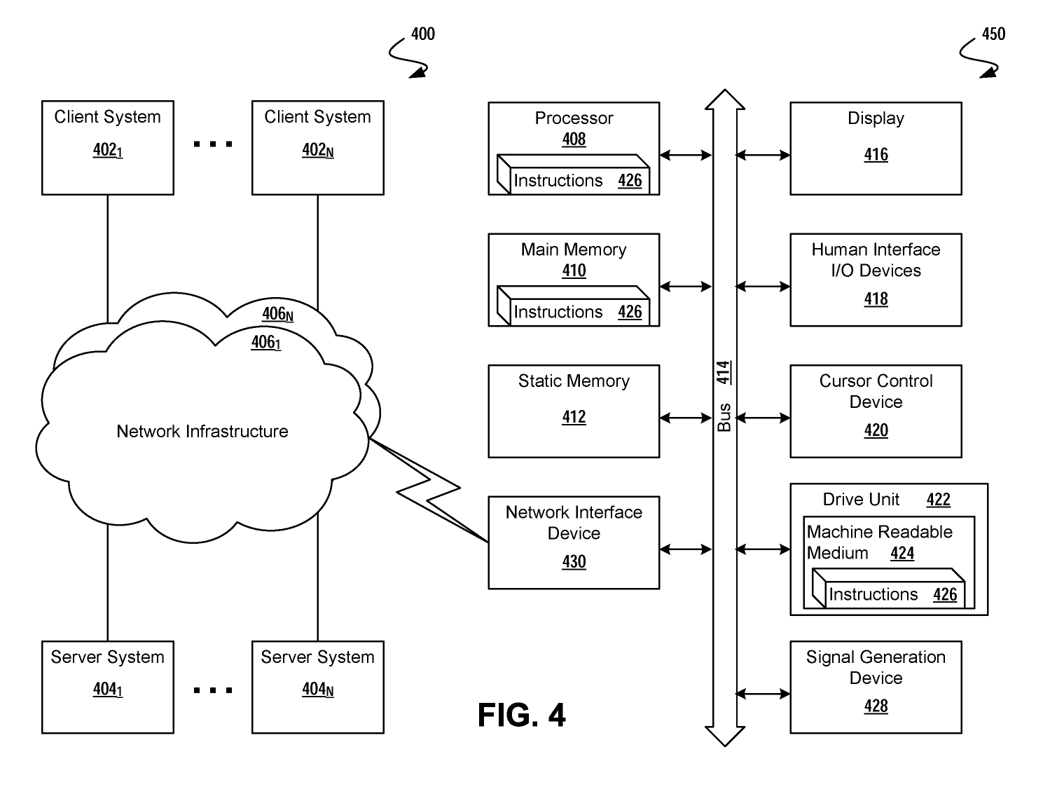

FIG. 4 is a diagrammatic representation of a network 400, including nodes for client systems 402₁ through 402_{N}, nodes for server systems 404₁ through 404_{N}, nodes for network infrastructure 406₁ through 406_{N}, any of which nodes may comprise a machine 450 within which a set of instructions, for causing the machine to perform any one of the techniques discussed above, may be executed. The embodiment shown is exemplary, and may be implemented in the context of one or more of the figures herein.

Any node of the network 400 may comprise a general-purpose processor, a digital signal processor (DSP), an application specific integrated circuit (ASIC), a field programmable gate array (FPGA) or other programmable logic device, discrete gate or transistor logic, discrete hardware components, or any combination thereof capable to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration, etc).

In alternative embodiments, a node may comprise a machine in the form of a virtual machine (VM), a virtual server, a virtual client, a virtual desktop, a virtual volume, a network router, a network switch, a network bridge, a personal digital assistant (PDA), a cellular telephone, a Web appliance, or any machine capable of executing a sequence of instructions that specify actions to be taken by that machine. Any node of the network may communicate cooperatively with another node on the network. In some embodiments, any node of the network may communicate cooperatively with every other node of the network. Further, any node or group of nodes on the network may comprise one or more computer systems (e.g., a client computer system, a server computer system) and/or may comprise one or more embedded computer systems, a massively parallel computer system, and/or a cloud computer system.

The computer system 450 includes a processor 408 (e.g., a processor core, a microprocessor, a computing device, etc.), a main memory 410 and a static memory 412, which communicate with each other via a bus 414. The machine 450 may further include a display unit 416 that may comprise a touch-screen, or a liquid crystal display (LCD), or a light emitting diode (LED) display, or a cathode ray tube (CRT). As shown, the computer system 450 also includes a human input/output (I/O) device 418 (e.g. a keyboard, an alphanumeric keypad, etc), a pointing device 420 (e.g., a mouse, a touch screen, etc), a drive unit 422 (e.g., a disk drive unit, a CD/DVD drive, a tangible computer readable removable media drive, an SSD storage device, etc.), a signal generation device 428 (e.g., a speaker, an audio output, etc.), and a network interface device 430 (e.g., an Ethernet interface, a wired network interface, a wireless network interface, a propagated signal interface, etc.).

The drive unit 422 includes a machine-readable medium 424 on which is stored a set of instructions 426 (e.g., software, firmware, middleware, etc.) embodying any one, or all, of the methodologies described above. The set of instructions 426 is also shown to reside, completely or at least partially, within the main memory 410 and/or within the processor 408. The set of instructions 426 may further be transmitted or received via the network interface device 430 over the network bus 414.

It is to be understood that embodiments of this invention may be used as, or to support, a set of instructions executed upon some form of processing core (such as the CPU of a computer) or otherwise implemented or realized upon or within a machine- or computer-readable medium. A machine-readable medium includes any mechanism for storing or transmitting information in a form readable by a machine (e.g., a computer). For example, a machine-readable medium includes read-only memory (ROM); random access memory (RAM); magnetic disk storage media; optical storage media; flash memory devices; electrical, optical or acoustical or any other type of media suitable for storing information.

### Advantages

The system is configured for capturing the future locations of where users are more likely to be on a declared date and time. Advantageously, the system utilizes the viral distributions of social connections to induce users to declare future locations. The system can increase the number of users who declare their future locations based on social proximity to be at a certain place at a future date and time. The system can increase the number of future locations captured per user. The system can increase the chances of a user to be at a declared future location because the user's social graph informs the system the user may have a special interest in a particular future location.

The system allows an ad servicing entity, such as an ad network, to share future locations with one or more advertisers for use in aimed ad campaigns. Improved ad campaigns make advertisers happy. The net effect of happy advertisers is more revenue for the ad servicing entity. Overall, the system provides a win-win for both the ad servicing entity and the advertisers.

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense.

What is claimed is:

1. A computer-implemented method for capturing a future location of a user, the method comprising:
receiving, at a computer, user data including plans for one or more future locations of one or more users;
identifying, at a computer, a particular user who is associated with one or more users who plan to go to a particular future location; and
providing to a particular user device a suggestion for the particular user to be at the particular future location, wherein the particular user device is presumably operated by the particular user.

2. The method of claim 1, wherein identifying the particular user comprises at least one of:
generating one or more social graphs based on the user data, wherein a social graph includes a collection of information pertaining to social associations between one or more users; and
using the one or more social graphs to identify a particular user who is associated with one or more users who plan to go to the particular future location.

3. The method of claim 2, wherein a social graph includes at least one of:
identifications of users;
identifications of friends of users;
identifications of contacts of users;
past locations of users;
past locations of friends of users;
past locations of contacts of users;
present locations of one or more users;
present locations of friends of users;
present locations of contacts of users;
declared future locations of users;
declared future locations of friends of users; and
declared future locations of contacts of users.

4. The method of claim 1, wherein the method further comprises receiving from the particular user device at least one of:
a response pertaining to the suggestion for the particular user to be at the particular future location;
an acceptance of the suggestion for the particular user to be at the particular future location;
a denial of the suggestion for the particular user to be at the particular future location; and
no response to the suggestion for the particular user to be at the particular future location.

5. The method of claim 1, wherein the method further comprises at least one of:
receiving from the particular user device an acceptance of the suggestion for the particular user to be at the particular future location;
booking the particular user for the particular location; and
performing monetization procedures based on the booking of the particular user for the particular future location.

6. The method of claim 1, wherein the method further comprises at least one of:
receiving from the particular user device a denial of the suggestion for the particular user to be at the particular future location;
notating the particular user does not plan to go to the particular future location; and
deciding not to book the particular user for the particular location.

7. The method of claim 1, wherein the method further comprises at least one of:
receiving from the user device no response to the suggestion for the particular user to be at the particular future location; and
deciding not to book the particular user for the particular location.

8. The method of claim 1, wherein the user data is received from at least one of:
a networking application;
an instant messaging application; and
a social networking application.

9. The method of claim 1, further comprising at least one of:
providing to the particular user device a way for the particular user to enter a future location without restriction to the suggestion for the particular user to be at the particular future location; and
providing to the particular user device a data entry device for the particular user to type in manually any future location that the user decides; and
providing to the particular user device a data entry device for the particular user to select on a geographical map any future location that the user decides.

10. The method of claim 9, further comprising at least one of:
receiving a manually entered future location from the particular user device; and
booking the manually entered future location as a declared future location of the particular user.

11. A system for capturing a future location of a user, the system comprising:
a computer system configured for:
receiving user data including plans for one or more future locations of one or more users;
identifying a particular user who is associated with one or more users who plan to go to a particular future location; and
providing to a particular user device a suggestion for the particular user to be at the particular future location, wherein the particular user device is presumably operated by the particular user.

12. The system of claim 11, wherein identifying the particular user further configures the computer system for at least one of:
generating one or more social graphs based on the user data, wherein a social graph includes a collection of information pertaining to social associations between one or more users; and
using the one or more social graphs to identify a particular user who is associated with one or more users who plan to go to the particular future location.

13. The system of claim 12, wherein a social graph includes at least one of:
identifications of users;
identifications of friends of users;
identifications of contacts of users;
past locations of users;
past locations of friends of users;
past locations of contacts of users;
present locations of one or more users;
present locations of friends of users;
present locations of contacts of users;
declared future locations of users;
declared future locations of friends of users; and
declared future locations of contacts of users.

14. The system of claim 11, wherein the computer system is further configured for receiving from the particular user device at least one of:
a response pertaining to the suggestion for the particular user to be at the particular future location;
an acceptance of the suggestion for the particular user to be at the particular future location;
a denial of the suggestion for the particular user to be at the particular future location; and
no response to the suggestion for the particular user to be at the particular future location.

15. The system of claim 11, wherein the computer system is further configured for at least one of:
receiving from the particular user device an acceptance of the suggestion for the particular user to be at the particular future location;
booking the particular user for the particular location; and
performing monetization procedures based on the booking of the particular user for the particular future location.

16. The system of claim 11, wherein the computer system is further configured for at least one of:
receiving from the particular user device a denial of the suggestion for the particular user to be at the particular future location;
notating the particular user does not plan to go to the particular future location; and
deciding not to book the particular user for the particular location.

17. The system of claim 11, wherein the computer system is further configured for at least one of:
receiving from the user device no response to the suggestion for the particular user to be at the particular future location; and
deciding not to book the particular user for the particular location.

18. The system of claim 11, wherein the computer system is configured to receive the user data is received from at least one of:
a networking application;
an instant messaging application; and
a social networking application.

19. The system of claim 11, wherein the computer system is further configured for at least one of:
providing to the particular user device a way for the particular user to enter a future location without restriction to the suggestion for the particular user to be at the particular future location; and
providing to the particular user device a data entry device for the particular user to type in manually any future location that the user decides; and
providing to the particular user device a data entry device for the particular user to select on a geographical map any future location that the user decides.

20. A computer readable medium comprising one or more instructions for capturing a future location of a user, wherein the one or more instructions are configured for causing one or more processors to perform the steps of:
receiving, at a computer, user data including plans for one or more future locations of one or more users;
identifying, at a computer, a particular user who is associated with one or more users who plan to go to a particular future location; and
providing to a particular user device a suggestion for the particular user to be at the particular future location, wherein the particular user device is presumably operated by the particular user.
